(19) United States
(12) Patent Application Publication
(10) Pub. No.: US 2008/0273913 A1
(43) Pub. Date: Nov. 6, 2008

(54) DISPOSABLE PRE-MOISTENED SCENT MATERIAL

(75) Inventors: Andrew Austreng, De Pere, WI (US); Mark E. Jansen, Appleton, WI (US)

Correspondence Address: DUANE MORRIS LLP - Philadelphia;IP DEPARTMENT, 30 SOUTH 17TH STREET, PHILADELPHIA, PA, 19103-4196, US

(73) Assignee: Madky Enterprises, LLC, De Pere, WI (US)

(21) Appl. No.: 12/112,254

(22) Filed: Apr. 30, 2008

Related U.S. Application Data
(60) Provisional application No. 60/927,307, filed on May 1, 2007.

(51) Int. Cl. B32B 5/00

(52) U.S. Cl. 401/118

(57) ABSTRACT

The present invention relates to a scent material including a single-use, disposable, pre-moistened, scented substrate hermetically sealed in a substantially vapor-impermeable package for easy and convenient use by persons pursuing outdoor activities involving potential interaction with wildlife, such as hunters, fishermen, or other outdoor activity enthusiasts, to either imitate natural or animal scents or mask human and other scents. The present invention further relates to a method of using a scent material for pursuing outdoor activities involving potential interaction with wildlife, which includes: (a) providing a substrate pre-moistened with at least one scent composition and hermetically sealed within a package with at least one substantially vapor-impermeable layer; (b) opening said package to access said substrate; and (c) wiping said substrate on a surface to impart said at least one scent composition to said surface, or alternatively, attaching said substrate to an object via attaching means.

### CROSS REFERENCE TO RELATED APPLICATIONS

The present application claims the benefit of U.S. Provisional Patent Application Ser. No. 60/927,307, filed May 1, 2007.

### FIELD OF THE INVENTION

The present invention relates to a scent material comprising a single-use, disposable, pre-moistened, scented substrate to be used for purposes of adding, altering, or masking scents in pursuing outdoor activities involving potential interaction with wildlife such as, for example, hunting, fishing, and wildlife observation, including photography.

### BACKGROUND OF THE INVENTION

A variety of scents, including cover scents, are used by outdoor activity enthusiasts, such as big game hunters, fishermen, and outdoor sportsmen to either mask or cover human scents or to imitate natural or animal scents. Scents currently are manufactured and sold in liquid or gel forms and are sprayed, dripped, or otherwise applied or attached to, e.g., a hunter's clothing, boots, or equipment. A hunter may use such liquid scents to apply to a textile patch or piece of material that he or she attaches to clothing or hangs at a hunting location to create a scent trail. Some scents may be dispensed by dripping around a hunting location to create a scent trail or mask the presence of the hunter. The scents comprise either secretions from live animals or are produced synthetically to imitate natural scents. A variety of scents are bottled and marketed to hunters; such scents include doe in estrus urine, buck in rut urine, gland secretions of male and female deer, fox, raccoon, and other animal urines, secretions, or natural scents.

Fishermen also use scent sprays or liquids to apply to bait or other fishing equipment to attract specific types of fish. Scents or bait sprays used by fishermen typically smell like live bait and appeal to a fish, such as imitation minnow or crawfish scents.

Current scent sprays, drops, gels, or liquids are marketed and sold to hunters and fishermen in a form that is designed for multiple uses. As such, liquids, gels, and sprays are inconvenient for hunters to use and carry in the field, and they are subject to overuse, spilling, evaporating, and drying up once a bottle is opened for initial use. For example, liquid scents are commonly packaged and sold in capped plastic bottles equipped with dispensing nozzles. The liquid is dispensed through the nozzle by tilting and squeezing the bottle. Once the cap of the bottle is opened for the first time, however, air enters the bottle and the area under the cap when resealed, causing the liquid to evaporate and/or the scent to oxidize and degrade during storage. These circumstances decrease the shelf life and maximum utility of such scent products, resulting in inefficient use or waste. Further, the bottle is susceptible to cracking or breaking, risking leakage or spilling of the liquid. Dispensation of the liquid through the nozzle also allows for error in application of a precisely desired amount of liquid such that the user may inadvertently dispense too much or too little of the liquid during any given application. Some prior art products also require refrigeration before or after opening the bottle, which is disadvantageous for those engaged for long periods of time in outdoor activities for which the scent is needed (e.g., several days).

U.S. Pat. No. 4,609,245 discloses a package for dispensing odors that resembles a felt-tip pen or marker. The pen-shaped receptacle has an internally disposed reservoir for containing a volume of scented liquid therein. A microporous conduit extends from the reservoir to an externally disposed dispensing tip for drawing the scented liquid outward from the reservoir via capillary action for evaporation at the dispensing tip. A cap is provided for placement over the dispensing tip. This device suffers from the flaw that, even with the cap placed over the dispensing tip, the scented liquid experiences unwanted evaporation during storage, due to there always being some exposure to the air within the cap, which effectively reduces the lifespan of the dispensing system.

U.S. Pat. No. 5,746,019 discloses a scenting system having a frangible vial containing scented liquid disposed within a flexible, moisture-proof sheath member and a wick member extending from the sheath member such that when the vial is broken, the scented liquid is released for evaporation through the wick member. This system is advantageous in that it allows the user to dispense the scented liquid without coming into contact with it and, while in the vial before the vial is broken, the scented liquid does not experience unwanted evaporation prior to use. Nevertheless, this system is designed for long-term, broadcast dispensation of the scent by hanging the system from a tree limb and, as such, it lacks the broad application and various uses of a pre-moistened substrate, such as, for example, wiping a substrate over a surface to impart the scent to that surface or attaching a substrate to apparel and dragging the substrate along a supporting surface, such as the ground, to leave a scent trail.

Embodiments of the present invention overcome the above-noted inconvenience of prior art scent products and are portable, disposable, designed for a one-time use, have a relatively longer shelf life, and provide a fresh and immediate scent in an ideal amount when used in the field.

### SUMMARY OF THE INVENTION

The present invention relates to a single-use, disposable, pre-moistened, scented substrate for use by persons pursuing outdoor activities involving potential interaction with wildlife, such as hunters, fishermen, or other outdoor activity enthusiasts, to either imitate natural or animal scents or mask human and other scents. A scent material for pursuing outdoor activities involving potential interaction with wildlife is provided, comprising a substrate pre-moistened with at least one scent composition, and a package with at least one substantially vapor-impermeable layer, wherein said substrate is hermetically sealed within said package.

The present invention further relates to a method of using a scent material for pursuing outdoor activities involving potential interaction with wildlife, which comprises: (a) providing a substrate pre-moistened with at least one scent composition and hermetically sealed within a package with at least one substantially vapor-impermeable layer; (b) opening said package to access said substrate; and (c) wiping said substrate on a surface to impart said at least one scent composition to said surface, or alternatively, attaching said substrate to an object via attaching means.

An object of the present invention is to provide a scent material that can be stored and transported easily into and out of the field by the user. Additional objects of the present invention are: (a) to provide a sealed, packaged substrate that ensures a fresh scent material for immediate use in the field; (b) to eliminate the inconvenience of multiple-use scent sprays, liquids, or gels; (c) to supply a minimal and appropriate amount of scent needed for the user's intended purpose; and (d) to prevent the over-use, evaporation or spilling of such scents in liquid, spray, or gel form.

### BRIEF DESCRIPTION OF THE DRAWINGS

These and other features and advantages will be more fully disclosed in, or rendered obvious by, the following detailed description of the preferred embodiments of the invention which are to be considered together with the accompanying drawings wherein like numbers refer to like parts and further wherein:

FIG. 1 is an isometric view of a sealed package enclosing a single disposable, pre-moistened scent material in accordance with an embodiment of the invention.

FIG. 2 is an isometric view of a disposable, pre-moistened scent material in an opened packaged in accordance with an embodiment of the invention.

FIG. 3 is an isometric view of a disposable, pre-moistened scent material with an aperture or slit in accordance with an embodiment of the invention.

### DETAILED DESCRIPTION OF THE INVENTION

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “joined,” “connected,” and “interconnected,” refer to a relationship wherein structures are secured or attached to one another either directly or indirectly through intervening structures, as well as both movable or rigid attachments or relationships, unless expressly described otherwise.

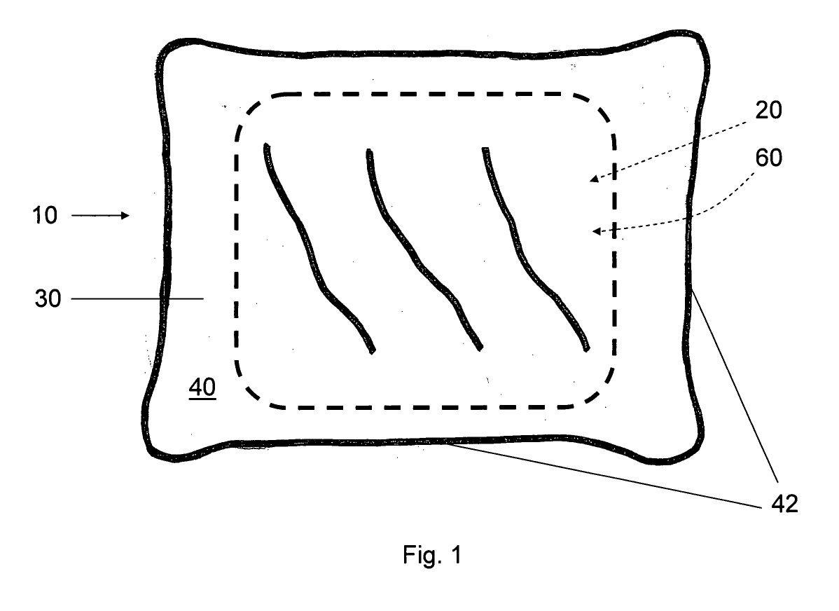

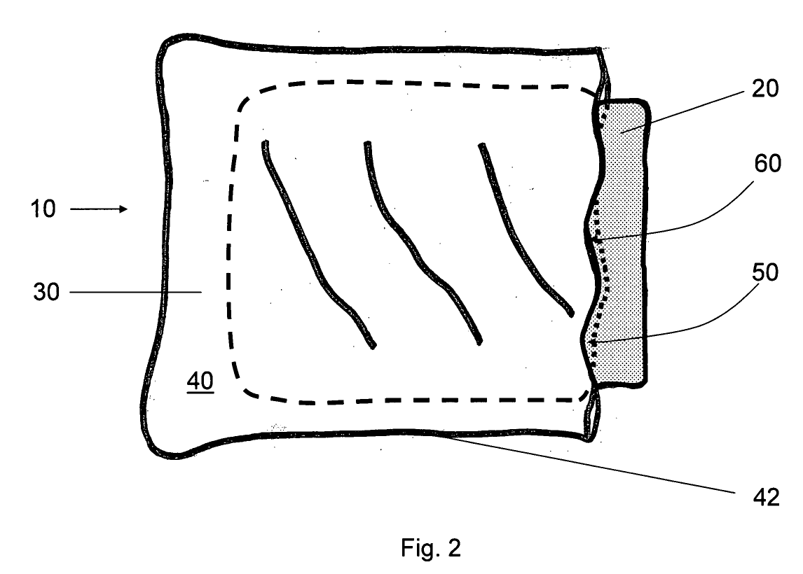

Referring to FIGS. 1 and 2, an embodiment of the invention includes a scent material 10, which comprises substrate 20 and package 30. Substrate 20 is pre-moistened with at least one scent composition. Package 30 has an external surface 40 and outer edges 42 and an internal surface 50 that defines an internal space 60. Substrate 20 is initially disposed within internal space 60. Substrate 20 and internal space 60 are hermetically sealed from the external environment around package 30 to prevent evaporation and loss of the scent composition from substrate 20. As shown in FIG. 2, substrate 20 is accessible for use when an area of package 30 near outer edge 42 is torn from the rest of package 30. Substrate 20 is then removable from internal space 60.

Substrate 20 may be made of any material suitable for being impregnated with at least one scent composition. Substrate 20 may comprise natural materials, synthetic materials, or a combination of natural and synthetic materials. Substrate 20 may comprise any number or combination of textile materials, including woven or non-woven flexible materials such as tissues, cloth, knits, weaves, scrims, or spun-bonded, point-bonded, mesh-type, carded, needled, or braided materials. Substrate 20 may comprise natural fibers such as cellulose, cotton, wool, linen, hemp, jute, grass, rush, etc. and/or synthetic polymers such as acetates, polyesters, polyethylenes, polypropylenes, etc. In preferred embodiments, substrate 20 is a non-woven spun-bonded material made of a combination of natural and synthetic fibers. For example, substrate 20 may comprise approximately fifty to sixty percent (about 50-60%) natural materials and fifty to forty percent (about 50-40%) synthetic materials. Substrate 20 preferably comprises materials that are compostable, recycled, recyclable, degradable, and/or biodegradable. Substrate 20 is easily and conveniently transportable and easily and conveniently disposable after it is used.

The substrate may be of various sizes and/or shapes. Substrate 20 may be any size and shape suitable for easy and convenient storage and transport. Substrate 20 may have a length of about 2 inches to about 6 inches, a width of about 1 inches to about 4 inches, and a thickness of about 0.125 inches to about 0.625 inches. In some embodiments, substrate 20 is substantially rectangular in shape measuring about three and one-half inches long by about two and one-half inches wide (approximately 3½″×2½″). In other embodiments, substrate 20 has measurements of about four and one-half inches long by about three and one-half inches wide (approximately 4½″×3½″). In yet other embodiments, substrate 20 is approximately the size and shape of a standard facial tissue, e.g., about eight and three-quarters inches long by about eight and one-third inches wide (approximately 8¾″×8⅓″). In these and other embodiments, substrate 20 may have a thickness of about 0.625 inches. Substrate 20 may have a single-ply thickness or multiple-ply thickness. In preferred embodiments, substrate 20 is pre-cut substantially into a square or rectangle that is approximately the size of a disposable towelette, hand wipe, baby wipe, napkin, or facial tissue. In embodiments where substrate 20 is larger than package 30, substrate 20 may be folded to fit in package 30. Further, substrate 20 may be printed or non-printed, embossed, opaque, pigmented, or transparent, and may or may not be treated with other additives, materials, liquids, or chemicals in addition to the natural or synthetic scents, such as, without limitation, additives used to preserve or otherwise prevent decomposition of substrate 20 or the scent composition prior to use. Substrate 20 may have straight, finished, or frayed edges, or it may have outer edges that are cut in a particular pattern, such as a zigzag, much like an edge created by pinking shears.

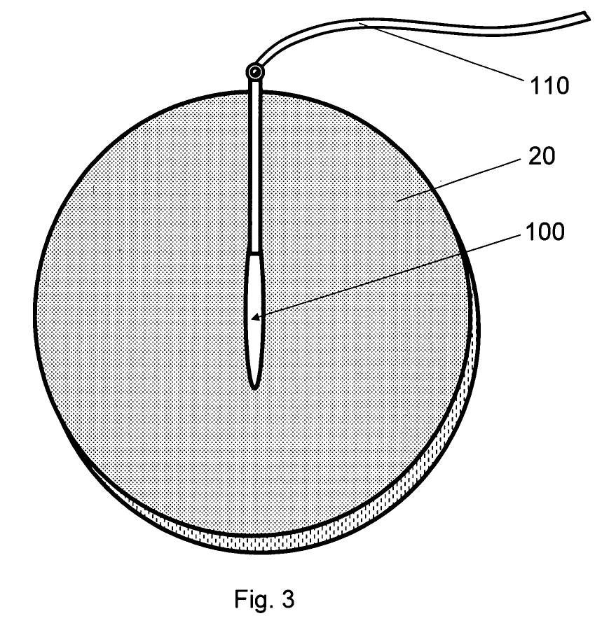

Referring to FIG. 3, in some embodiments, substrate 20 may include an aperture (such as a punch hole) or a slit 100. The aperture or slit 100 is advantageous for attaching substrate 20 to another object by any suitable means, such as, e.g., by a fastener, hook, clip, rope, string, wire, etc. As shown in FIG. 3, attaching means for attaching substrate 20 (shown as substantially circular in shape) to another object may be in the form of a string 110.

The size (length, width, and thickness), shape, and density of substrate 20 may be chosen to maximize absorption of the scent composition. Substrate 20 is impregnated or pre-moistened with a sufficient or effective amount of scent composition for the intended purpose. In some embodiments, substrate 20 is impregnated with a volume of scent composition of about one-half milliliters (½ ml) to about three-quarters milliliters (¾ ml). The volume of scent composition may be chosen based on the desired concentration and strength of the scent for the animal to which the scent corresponds. For example, a relatively lesser volume of scent may be preferable to attract a deer than to attract a bear. Often, a desirable amount of scent composition is enough to be detected by and intrigue the target animal, but not enough to alarm the animal. Accordingly, the size, shape, and/or density of substrate 20 may be a function of the volume of scent composition, or the volume of scent composition may be a function of the size, shape, and/or density of substrate 20, such that the size, shape, and/or density of substrate 20 are chosen based on a chosen volume of scent composition or a volume of scent composition is chosen based on the size, shape, and/or density of substrate 20. Preferably, the scent composition is absorbed by and saturates substrate 20 without leaving excess scent composition within package 30 when package 30 is opened and substrate 20 is used.

The scent composition used to saturate substrate 20 may include one or more natural compositions, one or more synthetic compositions, or a combination of one or more of each of a natural composition and a synthetic composition. The scent composition is applied to substrate 20 by immersing the substrate in a liquid or gel, spraying the substrate with a liquid, gel, or other coating, or coating the substrate with a scented liquid or gel, by any means, now known or later discovered. The scent composition corresponds to a target animal to mask human or other scents or to create scent trails that imitate the scents of live animals or other natural scents. For example, the scent composition may correspond to an animal that is game or prey of a hunter, such as, for example, deer (e.g., white-tailed deer, mule deer, etc.), elk, moose, or bear. The scent composition may include natural or synthetic doe in estrus urine, buck in rut urine, and other animal urine, any of a number of various gland secretions of male or female deer, fox, raccoon, elk, moose, bear, or other animal, or any other desirable scent. In some embodiments, the scent composition may correspond to bait used by a fisherman.

Package 30 may be made of any material suitable for hermetically sealing internal space 60 containing substrate 20 from the external environment around package 30. Package 30 may include at least one substantially vapor-impermeable layer such that the scent composition does not evaporate and substrate 20 does not become contaminated by external contaminants when substrate 20 is sealed within package 30. Package 30 may include one or more layers of coated paper, solid plastic film, shrink wrap film, paper/film, paper/foil, film/foil, or paper/film/foil combinations. Package 30 may comprise, without limitation, thermoplastic synthetic polymers, including polyolefins such as low density polyethylene, linear low density polyethylene, polypropylene coated with a layer of polyethylene, high density polyethylene, metallocene, electron-beam cured solid films, copolymers of ethylene and propylene and combinations of these polymers, polyesters, polyamides, polyvinyl polymers, and copolymers, and polylactic acid (PLA) resins or other degradable resin additives. In preferred embodiments, package 30 includes at least a first thermoplastic layer defining internal space 60, an intermediate foil layer, and a second thermoplastic layer overlaying the intermediate foil layer. Some embodiments include a layer of package 30 for printing or reverse-printing graphics and/or product labeling. Package 30 may include materials that are compostable, recycled, recyclable, degradable, and/or biodegradable. Package 30 may be easily and conveniently transportable and disposable after substrate 20 is used. In preferred embodiments, package 30 provides a sufficient seal to preserve a moist condition of the substrate 20 for a typical shelf life, under normal storage conditions, of at least two years.

In preferred embodiments, package 30 provides simple, quick access and dispensing of substrate 20. Package 30 preferably contains a single-use supply of scented substrate, as shown in FIGS. 1 and 2. These packages may be distributed individually or in bulk quantities with multiple individually packaged substrates stored in a single container. In other embodiments, package 30 may include a resealable container that contains more than one substrate 20. In such embodiments, package 30 maintains the moisture and freshness of a ready supply of multiple-scented substrates.

Scent material 10 including substrate 20 and package 30 is advantageously employed by those persons desiring to approach wildlife in close proximity, such as hunters, fishermen, sportsmen, naturalists, photographers, biologists, political activists, and law-enforcement personnel charged with the responsibility of protecting wildlife from injury, poaching, and the like. Such persons can easily store, transport, access, and use scent material 10 in the field as needed for their particular outdoor activities. Scent material 10 is subsequently easily disposed of as well.

To use the scent material 10, the user opens package 30 to gain access to the previously hermetically sealed substrate 20 impregnated with a scent composition. The user may wipe substrate 20 on the user's clothing, equipment, bait, the ground or other surface area to impart the scent of the scent composition or the user may hang substrate 20 in the field and allow the scent to diffuse into the environment. An embodiment wherein substrate 20 has an aperture 100 and/or attaching means for attaching the substrate to another object, such as a string 110, is preferred for hanging the substrate 20 in the field. The user may attach substrate 20 to the user's clothing via attaching means for attaching the substrate to another object. In some embodiments, the user attaches substrate 20 to the user's clothing via a lead or connector that may include a clip, such as an alligator clip. For example, the user may also attach substrate 20 to the user's pant cuff or footwear via a connector with an alligator clip, allowing substrate 20 to drag along a supporting surface, such as the ground, behind the user as the user walks, thereby creating a scent trail. Where substrate 20 is to be attached to another object, the user can open package 30 and manipulate the substrate in such a way that allows the user to attach the substrate to another object without the user coming into direct contact with the substrate and without touching the substrate with the user's bare hand.

It is to be understood that the present invention is by no means limited only to the particular constructions herein disclosed and shown in the drawings. The appended claims should be construed broadly to cover any variations or modifications within the scope or range of equivalents of the claims.

We claim:

1. A scent material for pursuing outdoor activities involving potential interaction with wildlife comprising:
a substrate pre-moistened with at least one scent composition, and
a package with at least one substantially vapor-impermeable layer,
wherein said substrate is hermetically sealed within said package.

2. The scent material of claim 1, wherein said scent composition comprises at least one of a natural composition or a synthetic composition.

3. The scent material of claim 2, wherein said scent composition comprises at least one of an animal urine and an animal gland secretion.

4. The scent material of claim 1, wherein only one substrate is hermetically sealed within said package.

5. The scent material of claim 1, wherein said package is resealable and contains more than one of said substrate.

6. The scent material of claim 1, wherein said substrate comprises an aperture.

7. A method of using a scent material for pursuing outdoor activities involving potential interaction with wildlife, which comprises:
(a) providing a substrate pre-moistened with at least one scent composition and hermetically sealed within a package with at least one substantially vapor-impermeable layer;
(b) opening said package to access said substrate; and
(c) wiping said substrate on a surface to impart said at least one scent composition to said surface, or alternatively, attaching said substrate to an object via attaching means.

8. The method of claim 7, wherein step (c) further comprises:
attaching said substrate to clothing, and
allowing said substrate to drag along a supporting surface to create a scent trail.

9. The method of claim 7, wherein said substrate is disposable.

10. The method of claim 9, wherein said substrate is a single-use substrate.

11. A method of adding, altering, or masking scent in pursuing outdoor activities involving potential interaction with wildlife which comprises:
(a) providing a single-use, disposable substrate pre-moistened with at least one scent composition and hermetically sealed within a package with at least one substantially vapor-impermeable layer;
(b) opening said package to access said substrate; and
(c) wiping said substrate on a surface to impart said at least one scent composition to said surface, or alternatively, attaching said substrate to an object via attaching means.

12. The method of claim 11, wherein step (c) further comprises:
attaching said substrate to clothing, and
allowing said substrate to drag along a supporting surface to create a scent trail.
